(19) United States
(12) Patent Application Publication
(10) Pub. No.: US 2016/0027425 A1
(43) Pub. Date: Jan. 28, 2016

(54) LATTICE STRUCTURES

(71) Applicant: MILWAUKEE SCHOOL OF ENGINEERING, Milwaukee, WI (US)

(72) Inventors: Douglas Lee Cook, Milwaukee, WI (US); Vito R. Gervasi, Pewaukee, WI (US)

(21) Appl. No.: 14/775,518

(22) PCT Filed: Mar. 13, 2014
(86) PCT No.: PCT/US14/26472

§ 371 Date: Sep. 11, 2015

Related U.S. Application Data
(60) Provisional application No. 61/851,776, filed on Mar. 13, 2013.
(60) Provisional application No. 61/851,751, filed on Mar. 13, 2013.

(51) Int. Cl. G10K 11/162; F28D 7/00

(52) U.S. Cl. CPC G10K 11/162; F28D 7/0058

(57) ABSTRACT

A unit cell for a lattice structure includes eight unit trusses disposed at vertices of the unit cell. A single unit truss is disposed at a centroid of the unit cell. Each of the nine unit trusses includes fourteen struts. Lattice structures are commonly used to connect various loads within a volume of space. Most such structures, however, have a rigid definition for their topology, and are unable to conform to shape or load directions. Additionally, conventional lattice structures are homogeneous, having dimensions and properties that are consistent throughout. These constraints, generally imposed for ease of manufacturing and assembly, prevent the development of highly robust and efficient structures, and limit the potential for multi-functional applications.

### CROSS-REFERENCE TO RELATED APPLICATIONS

This application is a non-provisional of and claims priority to U.S. Provisional Application No. 61/851,751, filed on Mar. 13, 2013 and U.S. Provisional Application No. 61/851,776, filed on Mar. 13, 2013. The entire contents of both applications are incorporated herein by reference.

### BACKGROUND OF THE INVENTION

Lattice structures are commonly used to connect various loads within a volume of space. Most such structures, however, have a rigid definition for their topology, and are unable to conform to shape or load directions. Additionally, conventional lattice structures are homogeneous, having dimensions and properties that are consistent throughout. These constraints, generally imposed for ease of manufacturing and assembly, prevent the development of highly robust and efficient structures, and limit the potential for multi-functional applications.

### SUMMARY OF THE INVENTION

The present invention relates to lattice structures, and in particular to unit trusses for building lattice structures.

In accordance with one construction of the invention, a unit cell for a lattice structure includes eight unit trusses disposed at vertices of the unit cell, and a single unit truss positioned within the unit cell, wherein each of the nine unit trusses includes fourteen struts.

In accordance with another construction of the invention, a unit truss for a lattice structure includes a junction, and fourteen struts coupled to the junction, six of the struts being mutually orthogonal, and eight of the inner struts oriented diagonally relative to each of the six mutually orthogonal struts.

In accordance with yet another construction of the invention, a lattice structure includes a unit cell having a plurality of struts that absorb loads selected from a group consisting of tensile loads, compressive loads, and shear loads, and a dual enclosing the unit cell, the dual represented by intersections between a rectangular prism, the unit cell, and octahedra.

Other aspects of the invention will become apparent by consideration of the detailed description and accompanying drawings.

### BRIEF DESCRIPTION OF THE DRAWINGS

FIG. 1 is a perspective view of a hexahedral unit cell according to one construction that includes nine unit trusses.

FIG. 2 is a schematic representation of the hexahedral unit cell.

FIG. 3 is a perspective view of one of the unit trusses.

FIGS. 4 and 5 are perspective views of constructions of lattice structures with unit cells that are modified to be non-rectangular.

FIGS. 6-8 are perspective views of the unit trusses being assembled together.

FIGS. 9-11 are perspective views of the unit trusses, illustrating different materials and sizes for struts within each of the unit trusses.

FIGS. 12-14 are perspective views of a lattice structure according to one construction, wherein at least one of the struts is made of an electrically-insulating material.

FIG. 15 is a perspective view of a cubic unit cell according to one construction.

FIG. 16 is a perspective view of a lattice structure according to one construction that incorporates a plurality of the cubic unit cells.

FIG. 17 is a diagram illustrating tensile and compressive loads on the lattice structure of FIG. 16.

FIGS. 18 and 19 are perspective views of principal stress and shear planes, and struts of one of the unit trusses aligned with the principal stress and shear planes.

FIG. 20 is a perspective view of a cube unit cell according to one construction, filled with material.

FIG. 21 is a perspective view of a supercube unit cell according to one construction, filled with material.

FIG. 22 is a perspective view of the cubic unit cell of FIG. 15, filled with material.

FIG. 23 is a perspective view of an octet unit cell according to one construction, filled with material.

FIG. 24 is a perspective view of an ultracube unit cell according to one construction, filled with material.

FIG. 25 is a perspective view of a lattice structure according to one construction with an outer cube-based layer and an inner ultracube-based layer.

FIG. 26 is a perspective view of an axial load member for the lattice structure of FIG. 25.

FIGS. 27 and 28 are perspective views of a lattice structure according to one construction that is a combination of cube unit cells and ultracube unit cells.

FIGS. 29-38 are perspective views of constructions of unit cells with associated duals.

FIG. 39 is a perspective view of a lattice structure according to one construction with hollow struts.

FIG. 40 is a perspective view of a lattice structure according to one construction with struts that have hydrofoil or airfoil geometry.

FIGS. 41 and 42 are schematic representations of stress ellipses for cross-sections of a strut.

FIG. 43 is a perspective view of a lattice structure according to one construction that includes conical struts.

FIG. 44 is a perspective view of a lattice structure according to one construction that includes sinusoidal struts.

FIG. 45 is a perspective view of a dual that includes faces made of different material.

FIG. 46 is a perspective view of a multifunctional thermal-management lattice structure according to one construction.

FIGS. 47-49 are perspective views of constructions of lattice structures that include custom composite gradients.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

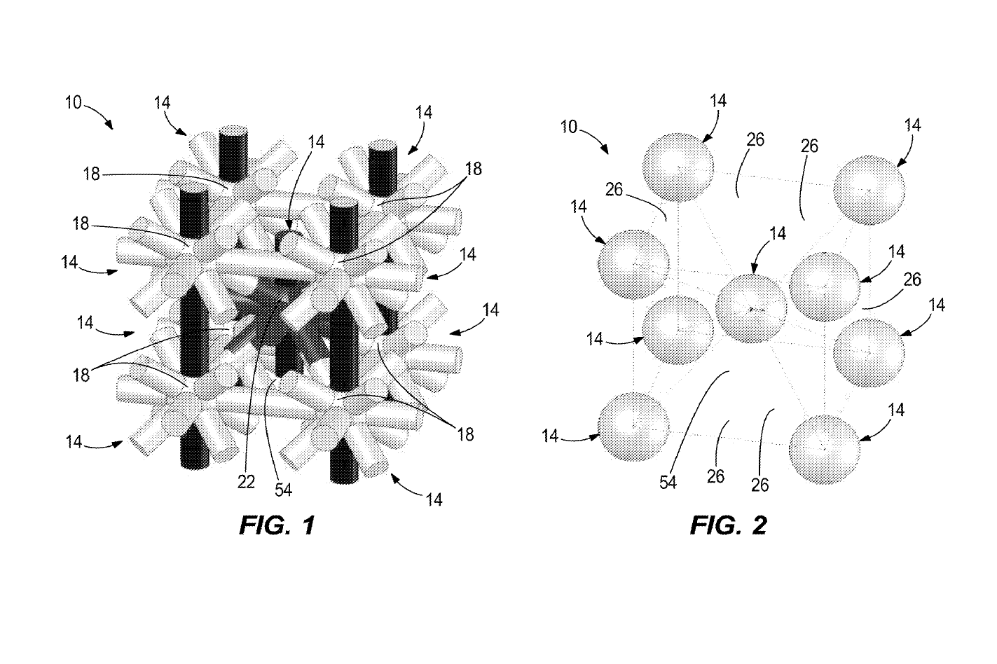

With reference to FIGS. 1 and 2, a hexahedral unit cell 10 includes nine unit trusses 14, eight of the unit trusses 14 being disposed at vertices 18 of the hexahedral unit cell 10 and one of the unit trusses 14 being positioned within the hexahedral unit cell 10. In one construction, one of the unit trusses 14 is disposed at a centroid 22 of hexahedral unit cell 10. In the illustrated construction, each unit truss 14 has exactly the same geometry and orientation within the hexahedral unit cell 10. As illustrated in FIG. 2, the illustrated hexahedral unit cell 10 resembles a body-centered cubic (BCC) crystal structure, with the vertices 18 forming six faces 26, the faces 26 defining planar, rectangular surfaces. The term unit truss 14, as referred to herein, is a unit lattice that may be of any size or scale.

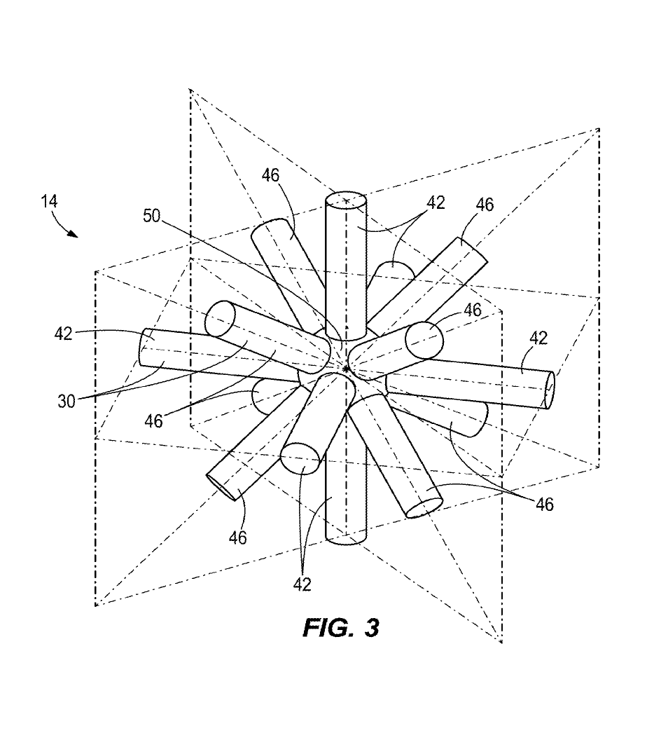

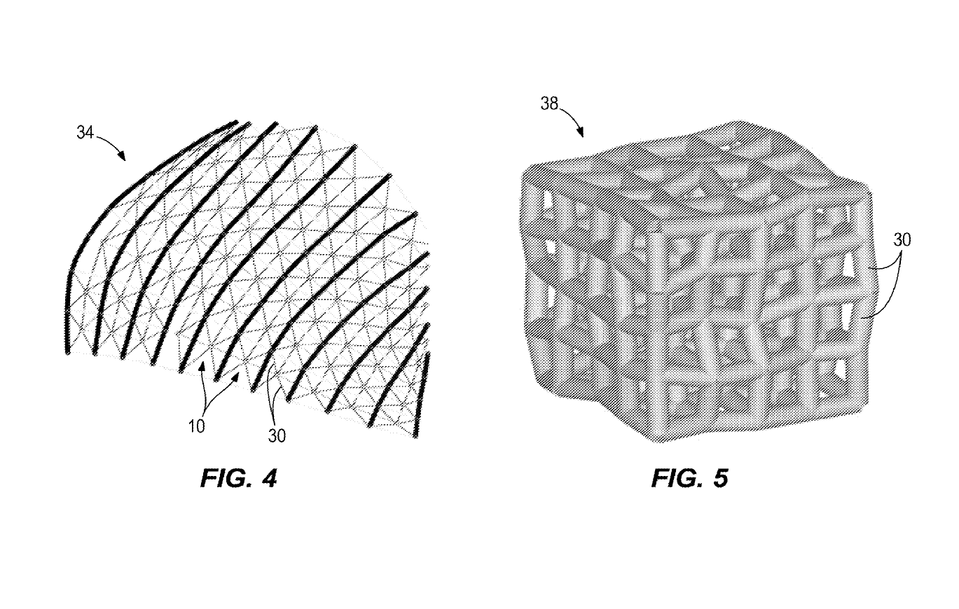

With reference to FIG. 3, each unit truss 14 has a maximum of fourteen struts 30 that are connection elements used to couple one or more of the trusses 14 together, as well as to absorb one or more loads (e.g., tensile, compressive, and shear). Depending on boundary conditions of the unit truss 14 (e.g., anticipated loads), some of the struts 30 in one or more of the unit trusses 14 may not be used (e.g., are removed) within each unit truss 14, to save material. Additionally, in some constructions, the faces 26 of the hexahedral unit cell 10 may not be arranged as planar, rectangular (or other parallelogram) surfaces like that in FIG. 2. For example, FIG. 4 illustrates a two-dimensional portional cross-section of a load-bearing lattice structure 34 utilizing multiple hexahedral unit cells 10 coupled together, where some of the struts 30 have been removed. FIG. 5 illustrates a three-dimensional image of a cubic-like lattice structure 38 of multiple hexahedral unit cells 10 where some of the struts 30 are oriented in an irregular pattern, such that faces in the lattice structure 38 are non-planar, and non-rectangular (in contrast to the faces 26 in FIG. 2).

With continued reference to FIG. 3, in the illustrated construction, six of the fourteen struts 30 of the unit truss 14 are mutually orthogonal struts 42 and eight of the fourteen struts 30 are diagonally-oriented struts 46 oriented diagonally relative to each of the six mutually orthogonal struts 42. As illustrated in FIG. 3, each of the eight diagonally-oriented struts 46 extends between three of the mutually orthogonal struts 42. In some construction fillets are disposed between the struts 30.

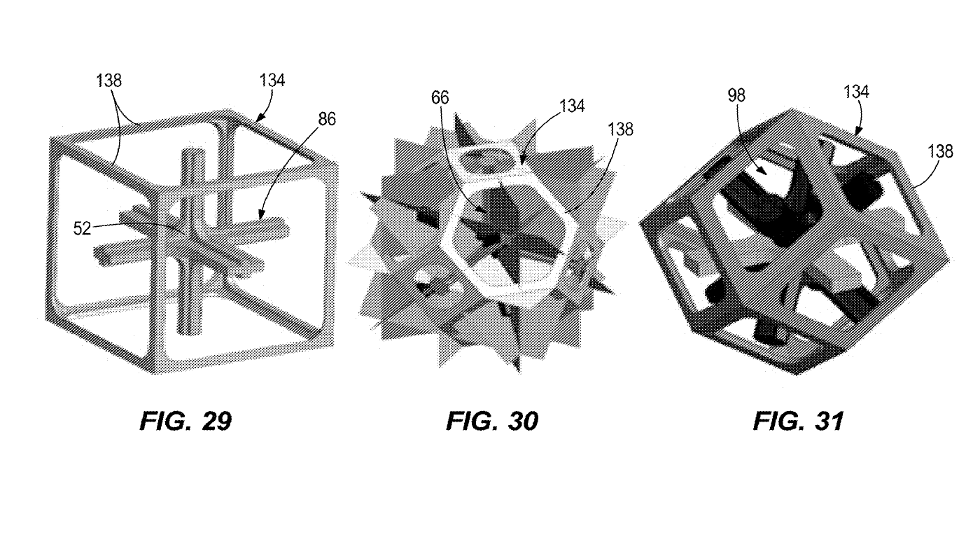

With continued reference to FIG. 3, the illustrated unit truss 14 further includes a junction 50 coupled to ends of each of the struts 30. In the illustrated construction, the junction 50 is a sphere (e.g., a hollow sphere) that minimizes stress concentrations within the unit truss 14, but in other constructions the junction 50 has other suitable geometries that minimize stress concentrations. In some constructions, the volume of the junction 50 is scaled depending on applied loads. In some constructions, the junction 50 includes chamfered and filleted gussets or webs (as seen in FIGS. 29-31 and 34-38) 52 between at least two of the struts 30, and/or is made of nested components. The webs 52 may extend between the two struts 30 at a portion of the length of the struts or along the entire length of the struts. The webs 52 may be solid or may include holes or occlusions or may be solid at one portion and have holes at another portion. The holes may be in a particular pattern or randomly distributed on the web 52.

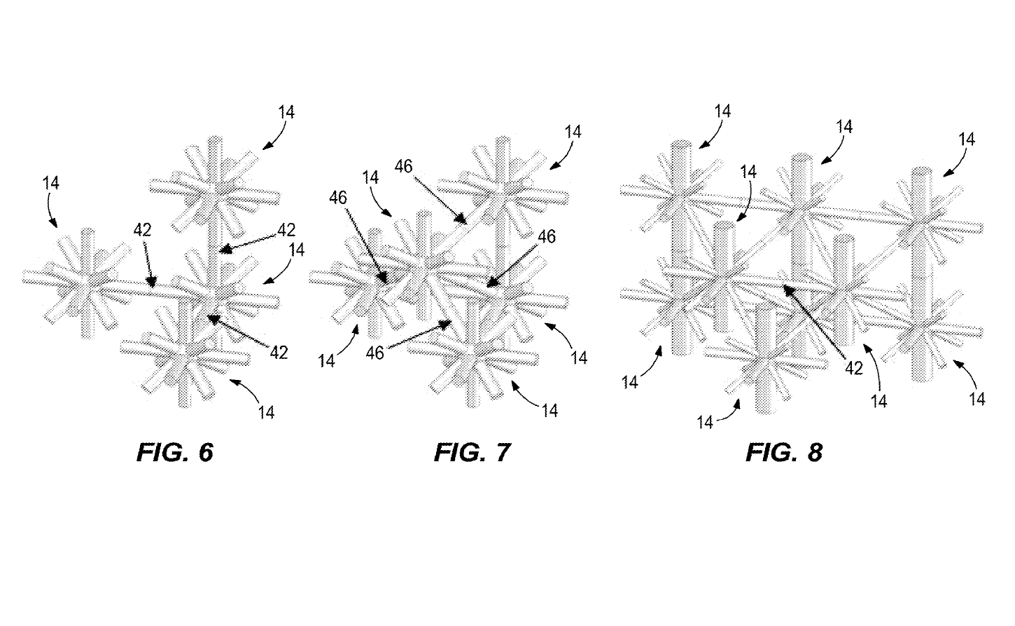

With reference to FIGS. 6-8, the unit trusses 14 are coupled together by coupling one or more of the struts 30 of one unit truss 14 with one or more of the struts 30 of another unit truss 14. As illustrated in FIG. 6, for example, the vertices 18 of the hexahedral unit cell or cells 10 are coupled together with at least three (and up to eight) of the mutually orthogonal struts 42 from each of the unit trusses 14. With reference to FIG. 7, the unit truss 14 at the centroid 22 is coupled to the unit trusses 14 at the vertices 18 with the diagonally-oriented struts 46 from each of the unit trusses 14 at the vertices 18 and the unit truss 14 at the centroid 22. With reference to FIG. 8, the orthogonally-oriented struts 42 (up to six) of the unit truss 14 at the centroid 22 couple the unit truss 14 at the centroid 22 with other unit trusses 14 at centroids of adjacent hexahedral unit cells 10.

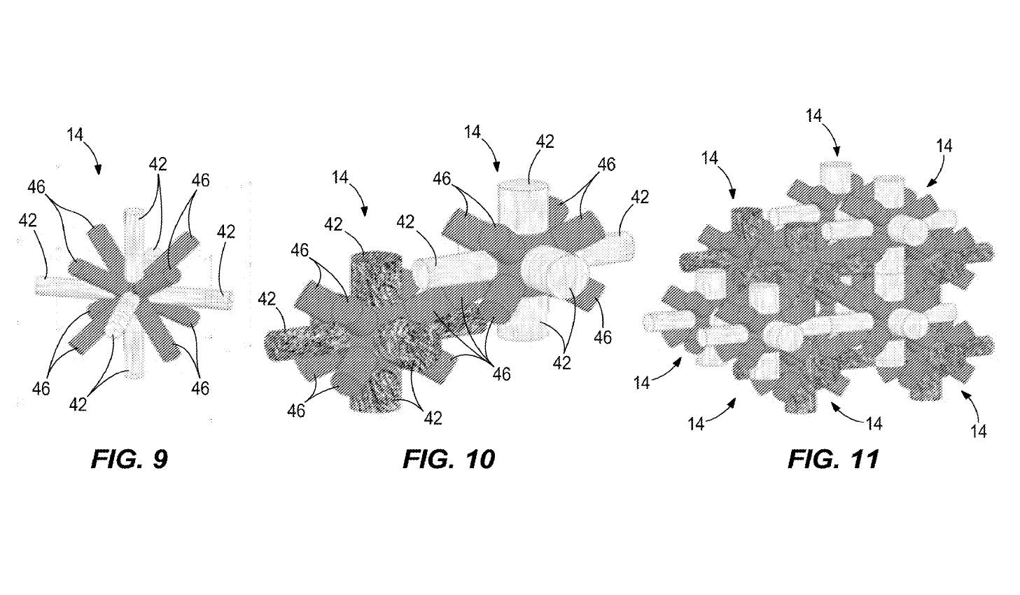

Within each unit truss 14, the individual struts 30 absorb one or more loads (e.g., tensile, compressive, and shear loads). In some constructions, the unit trusses 14 and struts 30 are oriented specifically with directions of force at each location throughout a lattice structure. With reference to FIGS. 6-8, in some constructions, the struts 30 are all made of the same material. With reference to FIGS. 9-11, in other constructions, some of the struts 30 (e.g., the mutually orthogonal struts 42) are made of a first material or composite material, and other struts (e.g., the diagonally-oriented struts 46) are made of a different material or composite material. In some constructions, the materials of the struts 30 differ from unit truss 14 to unit truss 14. With continued reference to FIGS. 9-11, in some constructions, the individual struts 30 of each unit truss 14 are sized independently according to anticipated forces applied to the struts 30. For example, as illustrated in FIG. 10, the mutually orthogonal struts 34 may have a diameter larger than that of the diagonally-oriented struts 38.

When load conditions and/or fabrication constraints demand, the mutually orthogonal struts 42 from the unit truss 14 at the centroid 22 are removed, leaving only those between the vertices 18. In these cases, the diagonally-oriented struts 46 connecting the unit truss 14 at the centroid 22 to the vertices 18 are “de-coupled” such that the diagonally-oriented struts 46 at the vertices 46 rotate about one orthogonal axis to lie between two of the mutually orthogonal struts 42. In this way, the diagonally-oriented struts 46 are coupled to those two directions.

With reference to FIGS. 1 and 2, the unit truss 14, and any lattice structure that is made of one or more of the unit trusses 14 (or hexahedral unit cells 10), includes at least one void region 54 between the struts 30 that in some constructions is occupied by particulates, foam, aerogels, electrolytes, or other material, allowing for additional functionality (e.g., pressurized-fluid storage, heat dissipation, or acoustic damping) of the unit truss 14.

The apparent density at each unit truss 14 is a function of the size and composition of each strut 30. Therefore, the apparent density at each point within any particular lattice structure that includes one or more of the unit trusses 14 is a function of the load at that point. This relation can be exploited to generate lattice structures that represent variable-density output of structural-optimization routines.

In some constructions, a lattice structure is defined by two “intertwined” orthogonal lattices, interconnected along the diagonally-oriented struts 46 of the unit trusses 14 to form a composite lattice configuration. In some of these composite lattice configurations, each of the orthogonal lattices separately handles a different load condition. For example, one of the orthogonal lattices is comprised of a material better suited for tensile loads, while the other is comprised of material better suited for compressive loads (e.g., one with larger diameter struts 30 like those illustrated in FIGS. 10 and 11). In some constructions of the composite lattice configuration the struts 30 of each orthogonal lattice structure are scaled independently, to a minimum of zero cross-sectional area, to minimize mass (effective density) within the composite lattice structure, and the diagonally-oriented struts 46 are used to carry the difference, (i.e., shear) in both tension and compression.

In some constructions, the composite lattice structure allows for the intertwining of mutually reactive materials, where one, or both may carry a load. In these constructions the diagonally-oriented struts 46 (non-reactive to either of the other two materials, or protected from reacting) hold the materials apart until a separator or barrier material is dissolved, melted, destroyed or otherwise removed. Alternatively, a catalyst, or third reactive material, is introduced, e.g., as, or carried by, a fluid, to initiate a reaction.

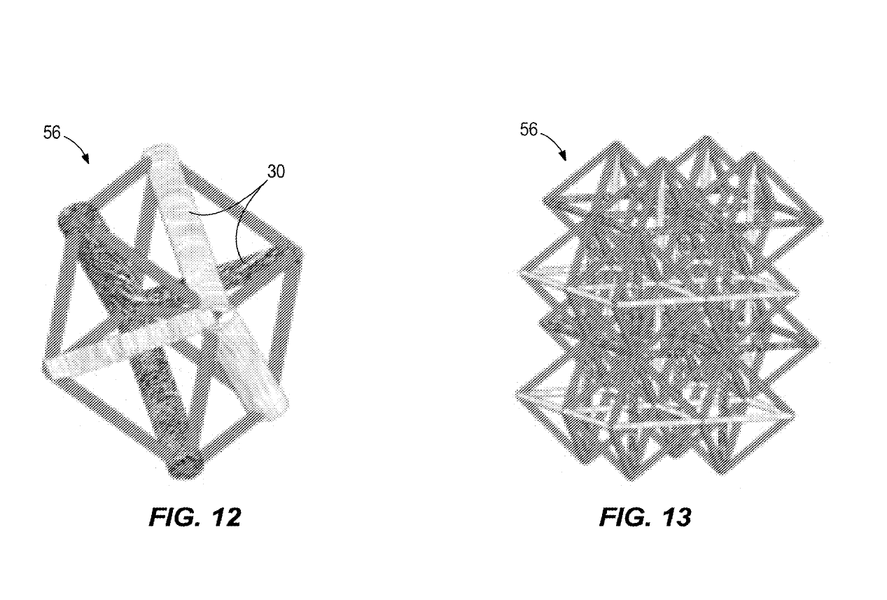

In some constructions, the diagonally-oriented struts 46 are made of an electrically-insulating material, allowing, for example, for each of the orthogonal lattices in the composite lattice structure to carry differing voltage potentials. With reference to FIGS. 12 and 13, for example, multi-material lattices 56 are illustrated, where at least one of the struts 30 is made of an electrically-insulating material, and where struts of different textures and sizes are used.

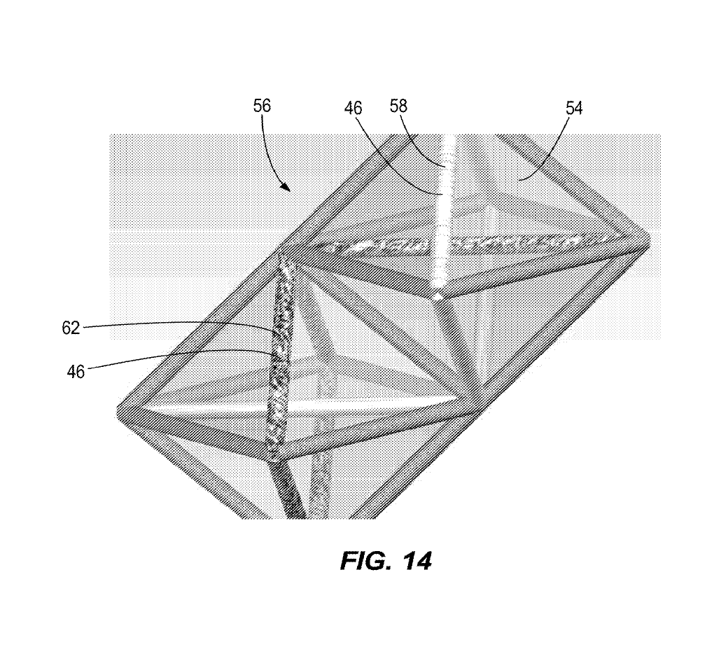

With reference to FIG. 14, in some constructions, the lattice structure 56 includes anodic struts 58 and cathodic struts 62 (in the illustrated construction both diagonally-oriented struts 46), and wherein the void region 54 is filled with electrolyte for a load-bearing power source.

With reference to FIG. 15, a cubic unit cell 66 includes one of the unit trusses 14 described above, wherein each of the fourteen struts 30 is an inner strut. The cubic unit cell 66 also includes twelve outer struts 70 that form edges of the cubic unit cell 66 and enclose the fourteen inner struts 30 in a cube-like manner.

In the illustrated construction, the twelve outer struts 70 carry either tensile loads or compressive loads, the six mutually orthogonal struts 42 carry the opposite loads, and the eight diagonally-oriented struts 46 carry resultant shear loads.

In some constructions each of the inner and outer struts 30, 70 is made of the same material. In some constructions each of mutually orthogonal struts 42 is made of a first material, each of the diagonally-oriented struts 46 is made of a second material, and each of the outer struts 70 is made of a third material, the first, second, and third materials each being different. Other constructions include different combinations of materials, sizes, and dimensions for the inner and outer struts 30, 70 than that illustrated.

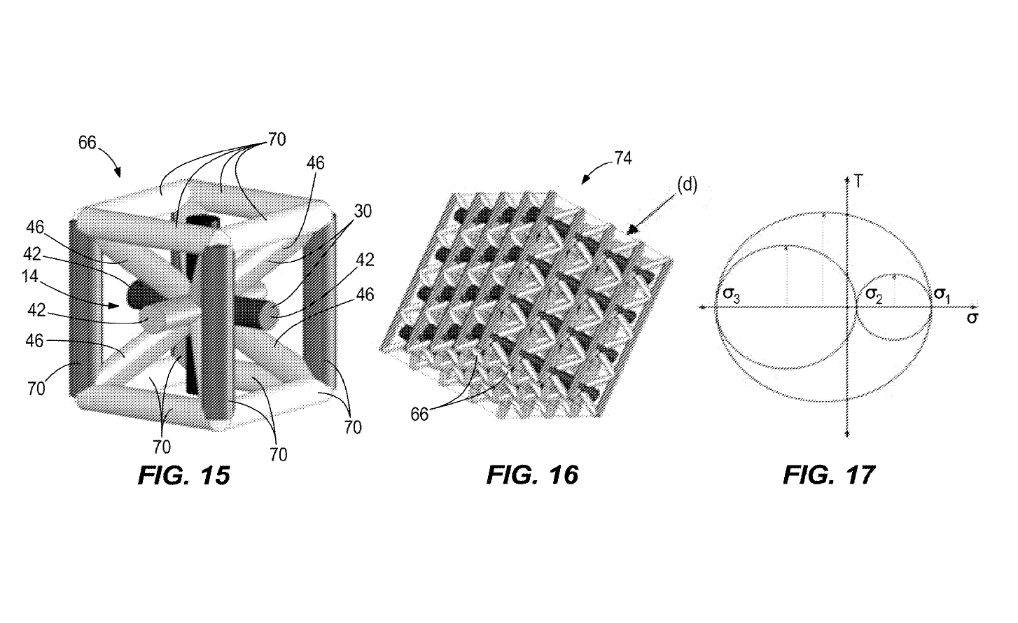

With reference to FIG. 16, a composite lattice structure 74 is illustrated that includes a plurality of the cubic unit cells 66. The struts 30 within the composite lattice structure 74 vary in size so as to absorb two loads of one type (e.g., tensile) and one load of another type (e.g., compressive) (as illustrated in the diagram in FIG. 17). The remaining loads are zero, so the remaining struts are scaled accordingly (shown as lines in FIG. 16 representing zero diameter for illustrative purposes).

The unit trusses 14, hexahedral unit cells 10, and cubic unit cells 66 are scale independent, and in some constructions are hierarchical. For example, a structure may be built with members having a lattice structure that includes one or more unit trusses 14, hexahedral unit cells 10, and/or cubic unit cells 66. Additionally, in some constructions, a hexahedral unit cell 10, cubic unit cell 66, or other lattice structure made of unit trusses 14 at one scale can occupy one octant of a unit cell (e.g., a hexahedral unit cell 10 or a cubic unit cell 66) of another scale.

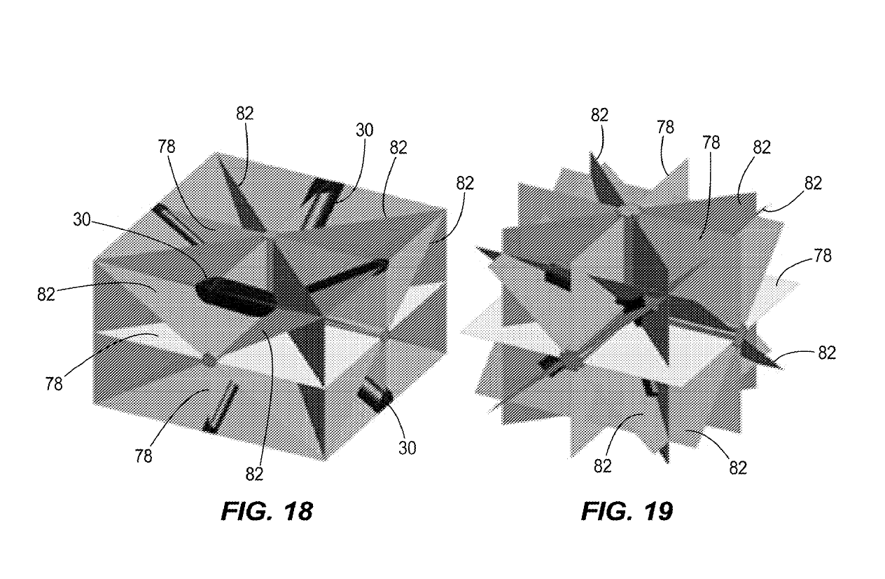

With reference to FIGS. 18 and 19, each of struts 30 within the unit truss 14 is aligned along the intersection of one or more principal stress planes 78 and principal shear planes 82, such that the principal stress and shear planes 78, 82 define a “structural skeleton” along these planes. In particular, each of the mutually orthogonal struts 42 is aligned along the intersection of two or more of the principal stress planes 78, and each of the diagonally-oriented struts 46 is aligned along the intersection of two or more of the principal shear planes 82. Depending on loads, scale, material, and fabrication constraints, and as described above, in some constructions, the unit truss 14 does not include one or more of the struts 30. For example, and with continued reference to FIG. 18, in some constructions, the unit truss 14 degenerates into only four tetralattice struts 30 (i.e., those with larger diameter illustrated in FIG. 18, one of which is not visible behind the planes 78, 82).

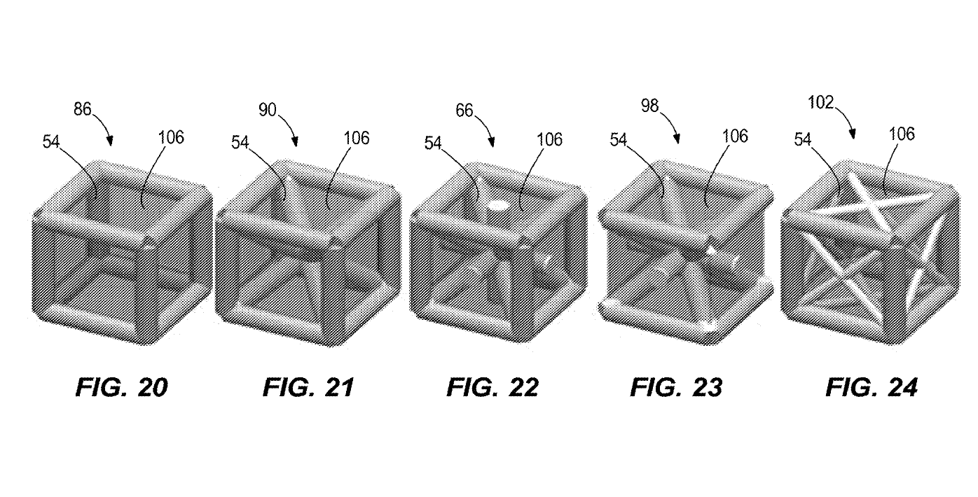

With reference to FIGS. 20-24, the intersection of the principal stress and shear planes 78, 82 define various types of unit cells, including a cube unit cell 86 (FIG. 20), a supercube unit cell 90 (FIG. 21), a modified supercube unit cell (i.e., the cubic unit cell 66 described above) (FIG. 22), an octet unit cell 98 (FIG. 23), and an ultracube unit cell 102 (FIG. 24). Each of these unit cells 86, 90, 66, 98, and 102 is formed at the intersection between four or five unit trusses 14, and in the illustrated construction, each of these unit cells 86, 90, 66, 98, 102 includes a void region 54 filled with an inner material 106 (e.g., a solid matrix, fluid, particulates, aerogels, etc.).

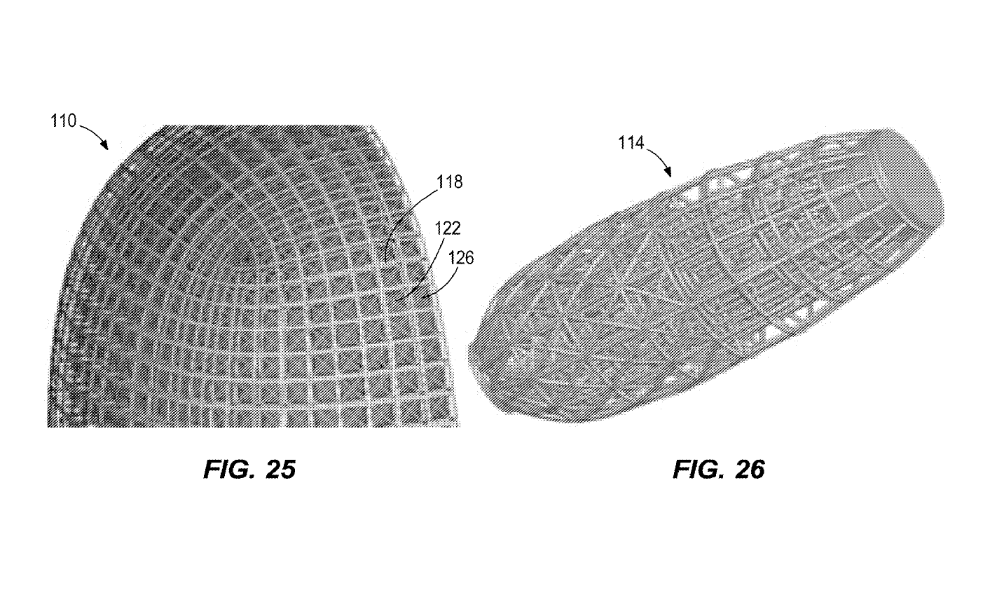

The “structural skeletons” defined by the struts 30 also include any transformation of these geometries, such as scaling, shearing, and bending, through which the defining planes 78, 82 may become surfaces, and their intersections may become curves. For example, FIGS. 25 and 26 illustrate a conceptual, lattice-based, multifunctional, composite, pressure-vessel section 110 (FIG. 25) and an axial-load member 114 (FIG. 26) for use, for example, within the pressure-vessel section 110 (FIG. 25) with geometric transformations applied to achieve a conformal lattice. In one construction, FIG. 25 illustrates a cube-based layer 118, an inner ultracube-based layer 122, and a solid inner liner 126. In some constructions the axial-load member 114 is a model of a low-mass, buckle-resistant, multi-function structure that carries load along and about its axis. As a hierarchical structure, this axial-load member 114 may be one strut in a larger unit cell (e.g., one strut in one of the ultracube unit cells 102 in the pressure-vessel structure 110.

In contrast to traditional composites, where composites are layered down in layers (i.e., a “layup” process) typically following a part's contour, the “layup” of lattice structures that employ unit trusses 14 has 360° of freedom about all three axes. In particular, the lattice structures follow loads, not necessarily a pre-defined part-volume geometry. For some geometries, such as pressure-vessels, the resultant orientations may be similar (e.g., as seen in FIG. 25). However, lattice structures may vary from one unit lattice to the next, allowing for much more complex geometries (e.g., as seen in FIGS. 4 and 5).

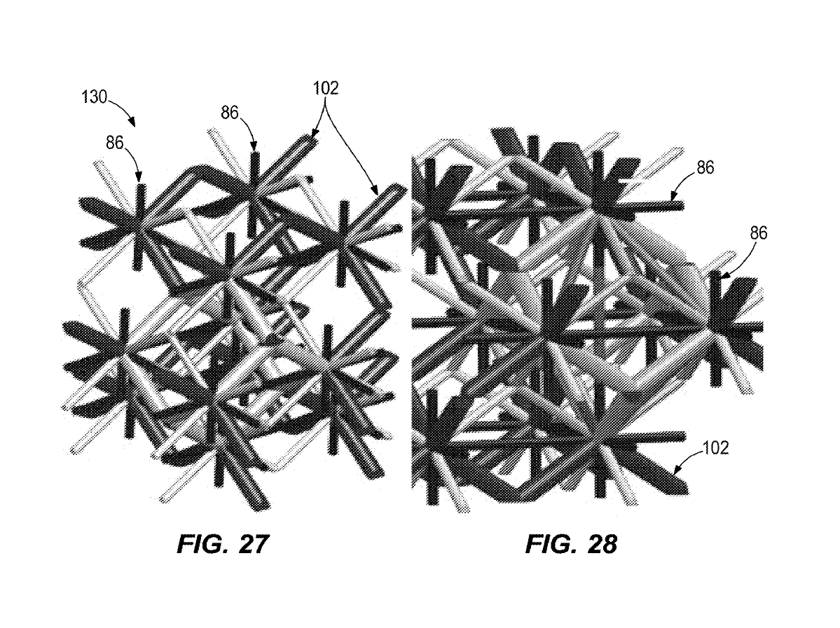

With reference to FIGS. 27 and 28, in some constructions, a lattice structure 130 includes a combination of cube unit cells 86 and ultracube unit cells 102. The layers of the lattice 130 can be offset, creating a body-centered-cubic-like connectivity. For example, and with continued reference to FIG. 27, the second layer of ultracube unit cells 102 from the bottom is shifted by one-half unit cell size in both directions in the plane of that layer. This connectivity includes a tetralattice geometry and an inverted tetralattice that may be removed for structural efficiency (reduced mass for similar performance), creating a rhombic dodecahedron geometry. With reference to FIG. 28, the connectivity may be altered between unit lattices, from offset-ultracube or tetralattice to modified supercube.

With reference to FIGS. 29-38, in some constructions a lattice structure includes a unit cell (e.g. hexahedral unit cell 10, cubic unit cell 66, a cube unit cell 86, supercube unit cell 90, an octet unit cell 98, or an ultracube unit cell 102) that is enclosed by a corresponding dual 134.

The unit cell and its dual 134 can be represented by intersections between a rectangular prism, the unit cell, and octahedral (dependent on size, position and rotation of octahedron relative to the rectangular prism). In some constructions, the unit cell and its dual 134 can be represented by truncated octahedron with orthogonal octahedral, each subdivided into four tetrahedral about principle axes. The strut count of the truncated octahedron can be reduced from three orthogonal rings to two, or just one, for further mass reduction and compliance. In some constructions the unit cell and its dual 134 can be represented by rhombic dodecahedron with octahedron and tetrahedral (octet). The strut count of the rhombic dodecahedron can be reduced to the tetralattice for further mass reduction and increased compliance.

With reference to FIGS. 29-31, planar web extrusions from each of the dual's faces generate struts 138 in the dual 134. For example, FIG. 29 illustrates a cube unit cell 86 enclosed within its dual 134, another cube. FIG. 30 illustrates a cubic unit cell 66 enclosed within its dual 134, a truncated octahedron. FIG. 31 illustrates an octet unit cell 98, composed of web extrusions in one principal stress and all six principal shear-stress planes, within its dual 134, a rhombic dodecahedron.

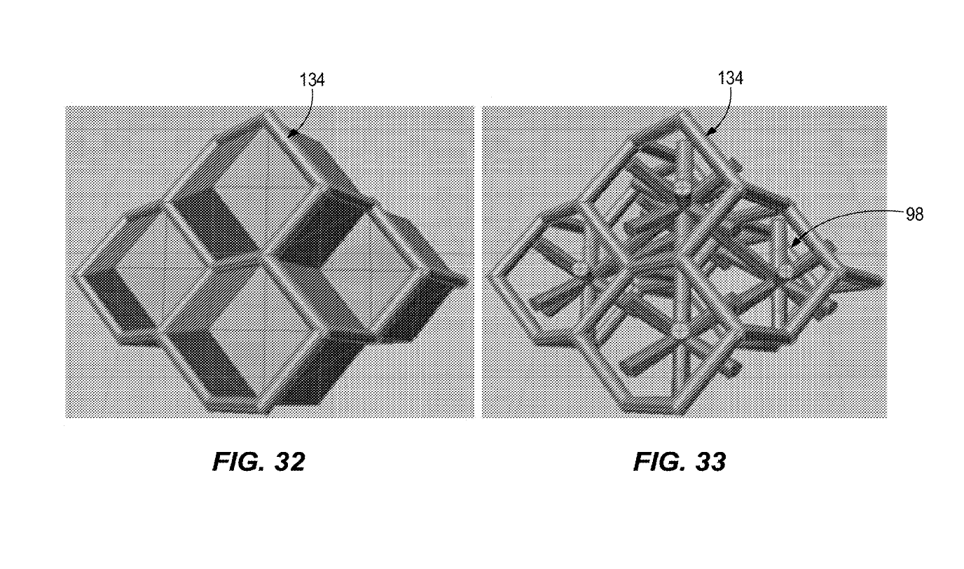

FIG. 32 illustrates a packed rhombic dodecahedra, which is a geometric dual 134 of the octet unit cell 98 in FIG. 31, with tetralattice generated along half of their edges, and FIG. 33 illustrates an octet unit cell 98 within a tetralattice dual 134. These are further examples of the degenerative potential of the lattice structures (i.e., from rhombic dodecahedron to tetralattice, by removing four struts).

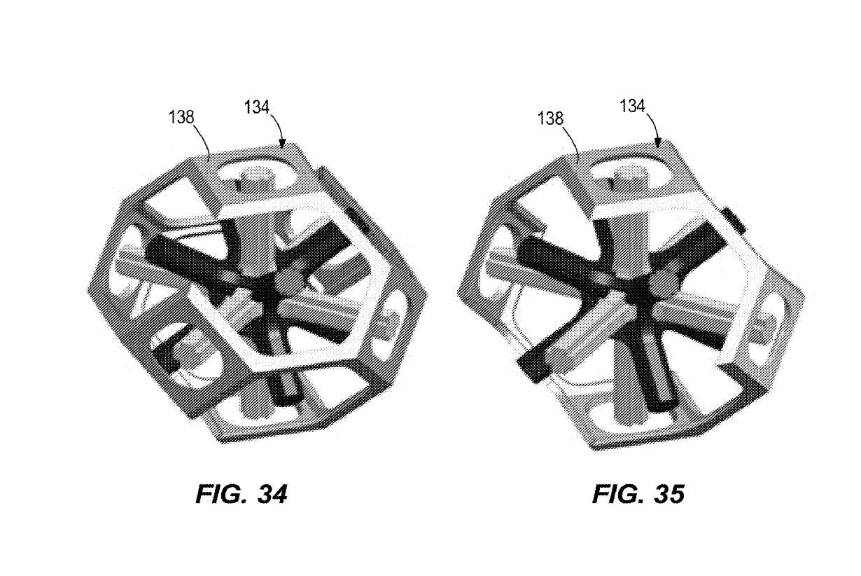

FIGS. 34 and 35 illustrate a truncated-octahedron dual 134. The strut counts of the truncated-octahedron dual 134 (and rhombic-dodecahedron dual 134) can be reduced from three orthogonal rings (in the planes of the octahedron edges, connecting the vertices) to two, or just one, for further mass reduction and compliance. In particular, FIG. 34 illustrates one orthogonal ring of connections having been removed from the truncated-octahedron dual 134. FIG. 35 illustrates two rings of connection having been removed, as well as faces that the two rings were supporting. The struts 138 of the truncated-octahedron dual 134 are generated from planar web extrusions, resulting in straight connections. These could follow the profile of the conic section that connects the vertices in that plane, or their mirror images about those edges.

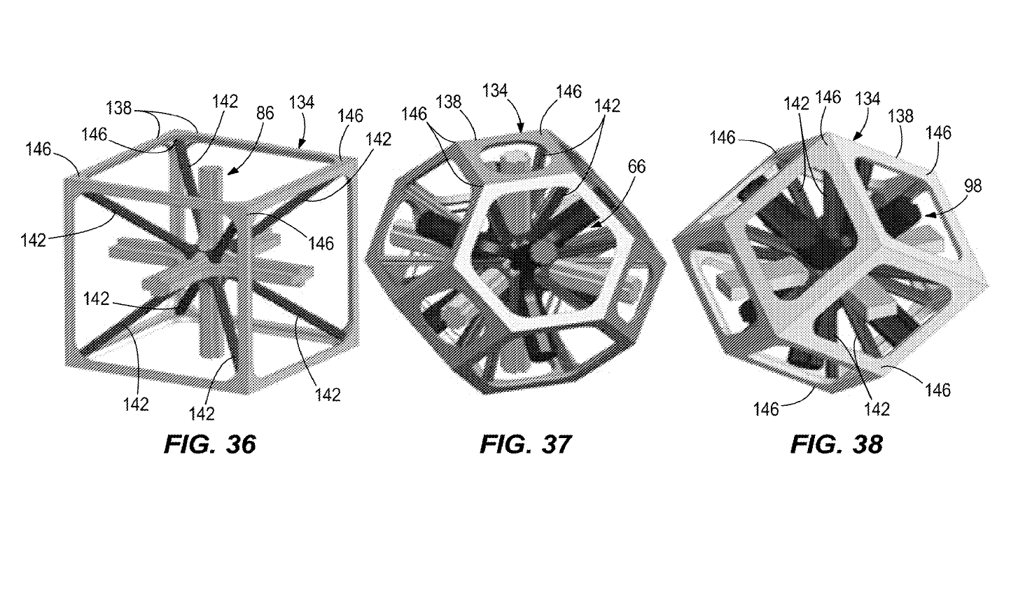

With reference to FIGS. 36-38, in some constructions the unit cell (e.g. hexahedral unit cell 10, cubic unit cell 66, cube unit cell 86, supercube unit cell 90, octet unit cell 98, or ultracube unit cell 102) is coupled to its dual 134 with ligaments 142, to provide for minimal addition of mass. For example, FIG. 36 illustrates a cube unit cell 86 and its dual 134 coupled together with ligaments 142, FIG. 37 illustrates a cubic unit cell 66 and its dual 134 coupled together with ligaments 142, and FIG. 38 illustrates an octet unit cell 98 and its dual 134 coupled together with ligaments 142.

The ligaments 142 couple the central junctions 50 of the unit cells to nodes 146 of the dual 134. In some constructions the ligaments 142 are made of the same material as the unit cell or dual 134. In other constructions the ligaments 142 are made of different material.

When there is no shear, i.e. pure hydrostatic loading within the unit cell, the diagonally-oriented struts 46 in the shear planes 82 can be removed and since there is only compression or tension, only one of the remaining intertwined cubic structures may be required, also negating the ligaments 142 there between. Under pure shear the “hydrostatic” struts (i.e., the mutually orthogonal struts 42) can be removed, as well as the ligaments 142 if they are not also the shear struts.

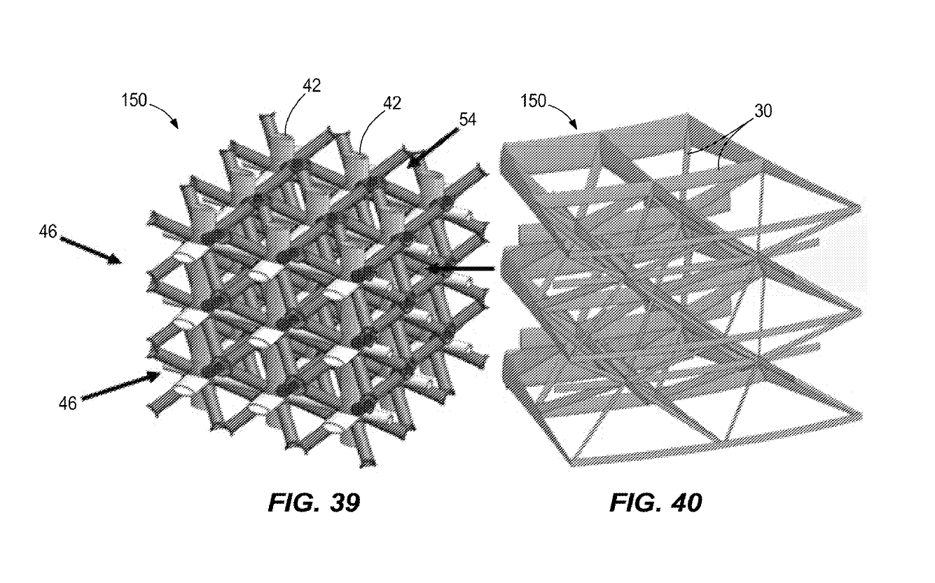

As described above, in some constructions the struts 30 are generated along the intersections of the principal stress and principal shear planes 78, 82. In other constructions the struts 30 are generated along bisectors between two such intersections in a plane, or about either (e.g., a spiral). The struts 30 may be of any cross-sectional type, including hollow. For example, and with reference to FIGS. 39 and 40, in some constructions a supercube lattice 150 includes a plurality of hollow hydrostatic-load struts (e.g., mutually orthogonal struts 42) enveloped within hollow shear-load struts (e.g., diagonally-oriented struts 46). The junctions of the shear-load struts are shown here with stress-minimizing bulb geometry. The separation of the two hollow structures provides separate fluid-flow paths for heat exchange, in addition the potential for external fluid through-flow.

With reference to FIG. 40, in some constructions the supercube lattice 150 is modified and degenerated into an octet. The struts 30 illustrated in FIG. 40 have hydrofoil (or airfoil) geometry (solid or hollow) for increased surface area and reduced drag for heat transfer to or from a flowing fluid.

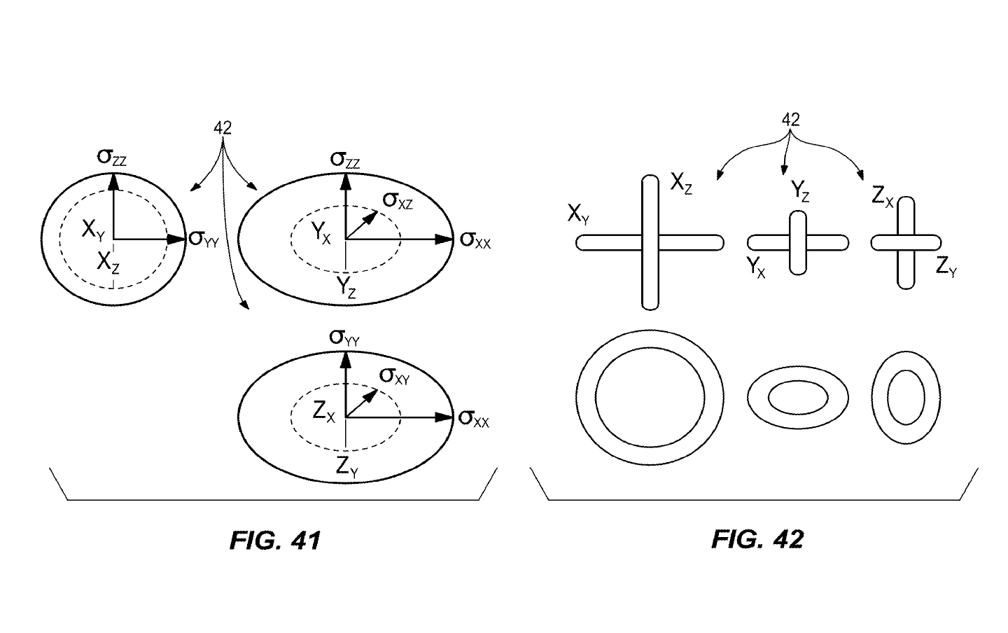

With reference to FIGS. 41 and 42, the cross-sections of the struts 30 in the lattice structures described herein, regardless of material, can also be of any shape, optimizable for desired functionality, and can change along the length of the struts 30. Generally, the minimum cross-sectional area for each strut is set so that:

$$\frac{Cell plane stress}{Cell plane area} = Plane Force ;$$

$$\frac{Plane Force}{Target Stress} = {A}_{Strut Cross Section}$$

The cube unit cell 86, having no shear struts (i.e. diagonally-oriented struts 46), can have the cross-sections of its mutually orthogonal struts 42 scaled proportionally to the average stress ellipse for that unit cell, while maintaining its required minimal cross-sectional area. For example, and as illustrated in FIG. 41 (which illustrates an example stress ellipse, shown in the X-Y, Y-Z, and X-Z planes, as well as a depiction of the proportional scaling that could be applied to the mutually orthogonal strut 42 of each) and FIG. 42 (which illustrates examples of strut cross-section stress-ellipse-proportional scaling, for both a cross and conic section type), the Y-direction strut 42 is normal to the X-Z plane, so the cross-section of the Y-direction strut 42 can be scaled to match the proportionality between the X-direction and Z-direction stresses. This improves shear-loading capacity.

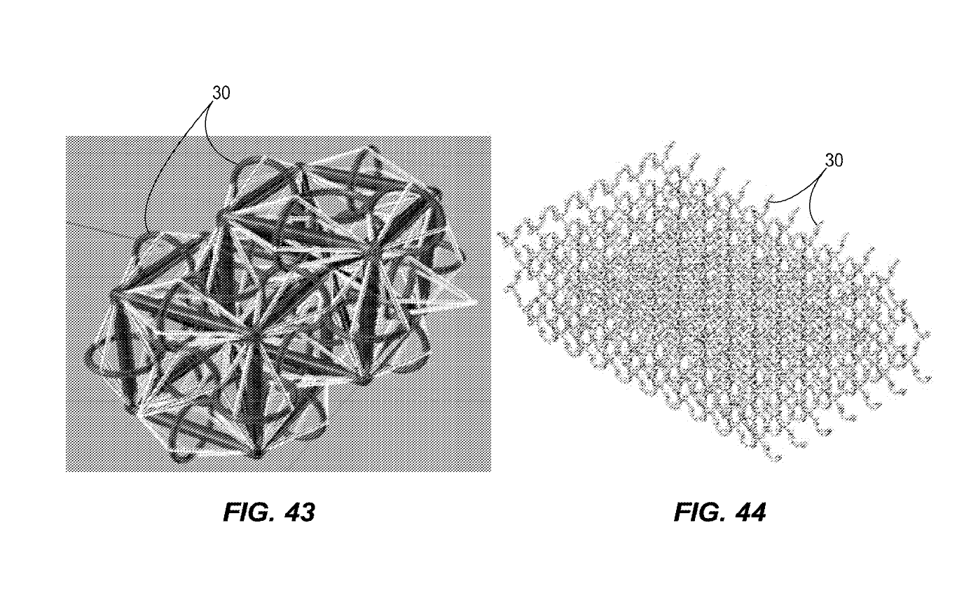

With reference to FIGS. 43 and 44, in some constructions the struts 30 are not straight. For example, as illustrated in FIG. 43, in some constructions some of the struts 30 are conical. As illustrated in FIG. 44, in some constructions the struts 30 are sinusoidal. The conical and sinusoidal struts 30 contain all cell nodes in one plane and can replace straight struts 30 for stiffness or compliance modification.

In some constructions the struts 30 are multiple entities bundled like wire, and their separation varies along the length of the strut 30 or ligament 142. In some constructions the struts 30 bend around other struts 30 or ligaments 142 instead of intersecting with them. In some constructions the struts 30 are generated as a web extruded from a plane (e.g., like struts 138 described above). In some constructions the struts 30 are enclosed with a shell or shrink-wrap geometry, and/or have edges and corners that are filleted or chamfered.

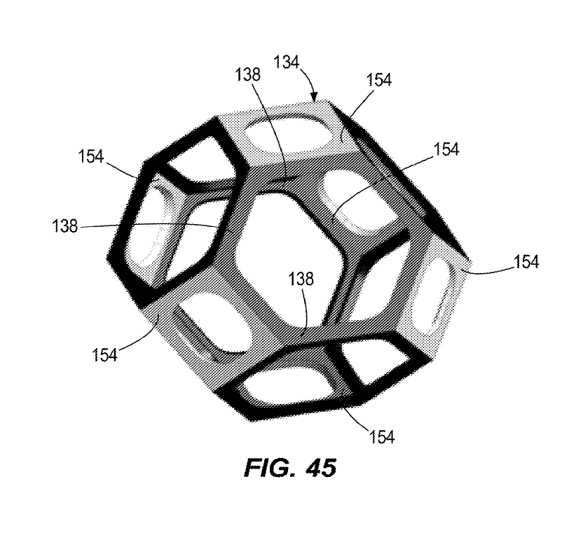

With reference to FIG. 45, in some constructions the duals 134 include multiple faces 154 (e.g., six faces of a truncated-octahedron dual 134 as illustrated in FIG. 45) that each have a different material, thickness, and/or profile, and wherein the struts 138 are made of yet another material different than the material for each of the faces 154.

In some constructions, a lattice structure (e.g., one which includes the unit truss 14, hexahedral unit cell 10, cubic unit cell 66, cube unit cell 86, supercube unit cell 90, octet unit cell 98, and/or ultracube unit cell 102) includes protrusions and/or intrusions on internal or external surfaces of the lattice structure for increased surface area. The protrusions and/or intrusions provide heat transfer, electrochemical reactions, and biological cell growth.

In some constructions a lattice structure includes metal plating or other conformal coatings. Proportions of mixed materials in fabrication can lead to a gradient between stiffness and compliance within the lattice structure.

In some constructions, an octahedral lattice structure is subdivided into tetrahedral lattice structures. In some constructions a rectangular prism is subdivided into smaller rectangular prisms, each of which is further subdivided. This subdivision continues until limits of fabrications are met, at both ends of the structure's scale. These prisms are then used for generating a structural skeleton at their respective size scales, resulting in a fractal lattice structure.

As the minimal strut dimensions approach fabrication limits during assembly of a lattice structure, struts 30 can be removed, allowing for the remainder to be scaled up while maintaining low total mass. The minimal form is the tetralattice. An offset ultracube unit cell 102 degenerates into the tetralattice, oriented with principle stress planes 78. A cubic unit cell 66 degenerates into a tetralattice rotated with one principle stress plane 78 and two shear stress planes 82. As noted above with regards to FIGS. 34 and 35, a truncated octahedron can be reduced from three orthogonal rings, to two or one.

In some constructions, a lattice structure includes multiple different types of unit cells or modified unit cells (e.g. hexahedral unit cell 10, cubic unit cell 66, cube unit cell 86, supercube unit cell 90, octet unit cell 98, and ultracube unit cell 102) and their duals 134. The lattice structures can be aligned with potential fields (e.g., pressure, temperature, voltage, magnetism and gravity). In some constructions, two struts 30 lie in, or are tangent to, an isosurface (surface of constant magnitude through a potential field), while a third strut 30 is normal to the isolevel at that point, or tangent to that normal at that point.

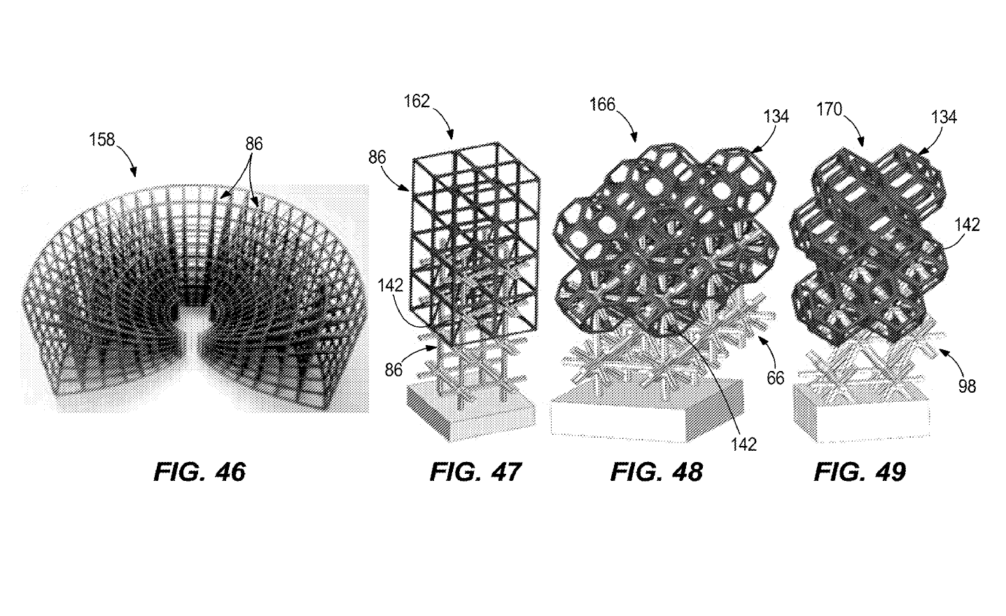

With reference to FIG. 46, a multifunctional thermal-management lattice structure 158 is illustrated that is formed using the cube unit cells 86 to safely integrate a power source into a medical device. In addition to sinking heat, the lattice structure 158 is intended to handle axial loading and moderate torsion.

In some constructions, the thermal conductivity of a lattice structure is optimized to match that of thermoelectric generators, maximizing power conversion. A void region between the unit cell and its dual 134 can be filled with a phase-change material for latent-heat storage, such as that desired for solar water heaters, with one lattice connected to a source (solar heater), and the other to a sink (“hot water” pipe).

In some constructions, a lattice structure optimizes material, strut geometry and cell size for manipulation and optimal attenuation of acoustic (fluid pressures) waves, for example via reflection and interference (“sonic crystal”) or via viscous damping of fluid oscillatory flow. The lattice structure can route pressure waves through the three-dimensional structure.

In some constructions, a lattice structure optimizes material, strut geometry and cell size for manipulation of electromagnetic radiation transmission, through filtering, reflection and refraction, for applications such as routing, collimation and lensing, including concentration and diffusion.

In some constructions, a lattice structure optimizes material, strut geometry and cell size for manipulation of magnetic fields and flux.

In some constructions, a lattice structure includes custom composite gradients (e.g., solid to foam, and stiff to compliant). For example, and with reference to FIG. 47, a lattice structure 162 includes a transition between solid cube unit cells 86 (disposed at the bottom) and foam cube unit cells 86 (disposed at the top), connected by ligaments 142. With reference to FIG. 48, a lattice structure 166 includes a transition between solid cubic unit cells 66 and foam truncated octahedron duals 134, connected by ligaments 142. With reference to FIG. 49, a lattice structure 170 includes a transition between solid octet unit cells 98 and foam rhombic-docecahedron duals 134, connected by ligaments 142. In some constructions a lattice changes relative density (volume fraction) of either unit lattice for gradient density too. In some constructions select facts of the foam cells may be closed, and/or multiple foam cell types are used.

In some constructions, cell unit size, strut dimensions, and material selection are set such that the applied load will drastically deform the lattice (including failure) for impact absorption (strain energy converted to heat, rather than stored). The modifications may be made globally or locally within the full structure, and may be a gradient or multiple gradients.

In some constructions, cell unit size, strut dimensions, and material selection are set such that the applied load elastically deforms the lattice (without plastic deformation) at a requisite strain to achieve a target storage capacity of strain energy.

In some constructions, cell unit size, strut dimensions, and material selection are set for filtration of particulates from fluids, and separation of mixed fluids that have different viscosities, including routing of the fluids through the lattice structure. A volume fraction (ratio of fluid to solid structure) can vary throughout the structure for variable filterability. Fractal-generated structures provide more pores in specific regions for a given volume fraction. Free struts 30, for example those that do not mate with a strut 30 of an adjacent unit truss 14, may be removed if a one-unit-cell length extension does not result in a mate. In fractals, the extension may be up to one cell length of a cell one level up in the hierarchy.

The lattice structures described herein advantageously reduce weight. For example, the high inter-connectivity of the unit trusses 14 minimizes oversizing, and the unit trusses 14 are custom-sized to handle loads in multiple directions (e.g., with safety factors included).

The unit trusses 14 can be manufactured with up to three separate materials (e.g., one for tensile loads, one for compressive loads, and one for shear loads).

Bearing surfaces are achieved with functionally-gradient lattices where the composition of the unit trusses 14 changes through the component, based on functional requirements. The custom inter-connectedness of intertwined lattices minimizes weight.

In some constructions, the unit trusses 14 are made of a more compliant material for energy absorption. In some constructions the diagonally-oriented struts 46 are made of an elastomer, whose stiffness may vary throughout the structure.

The high surface-to-volume ratio of internal channels allows for effective heat transfer between the lattice structure and any fluid(s) within the channels. In some constructions, the unit trusses 14 are also be hollow to allow fluid to flow internal to the lattice structure. The custom inter-connectedness of intertwined lattices allows the lattice (functioning as a heat exchanger) to more effectively bear mechanical loads.

In some constructions, the lattice structure includes phononic band gaps. For example, the unit trusses 14 re spaced for noise filtering. These band gaps may be “stackable.”

Although the invention has been described in detail with reference to certain preferred embodiments, variations and modifications exist within the scope and spirit of one or more independent aspects of the invention as described.

What is claimed is:

1. A unit cell for a lattice structure comprising:
eight unit trusses disposed at vertices of the unit cell; and
a single unit truss positioned within the unit cell;
wherein each of the nine unit trusses includes fourteen struts.

2. The unit cell of claim 1, wherein in a single unit truss, six of the fourteen struts are mutually orthogonal at junctions of the mutually orthogonal struts, and eight of the struts are oriented diagonally relative to each of the six mutually orthogonal struts.

3. The unit cell of claim 2, wherein the six mutually orthogonal struts are arranged to absorb tensile and compressive loads within the unit cell, and the eight diagonally-oriented struts are arranged to absorb shear loads within the unit cell.

4. The unit cell of claim 2, wherein the six mutually orthogonal struts are made of a first material and the eight diagonally-oriented struts are made of a second, different material.

5. The unit cell of claim 2, wherein one of the eight diagonally-oriented struts of one of the eight unit trusses disposed at the vertices is coupled to one of the diagonally-oriented struts of the single unit truss at the centroid.

6. The unit cell of claim 2, wherein one of the six mutually orthogonal struts of one of the eight unit trusses disposed at the vertices is coupled to one of the six mutually orthogonal struts of another one of the eight unit trusses disposed at the vertices.

7. The unit cell of claim 1, wherein the struts and unit trusses form a void within the unit cell, and wherein the void is filled with material.

8. The unit cell of claim 1, wherein one of the struts has a first diameter, and another of the struts has a second diameter larger than the first diameter.

9. A lattice structure formed with at least one of the unit cells of claim 1.

10. A lattice structure formed with at least one variation of the unit cell of claim 1, wherein the variation includes removal of at least one of the fourteen struts.

11. A unit cell of claim 1 further comprising a web coupled between two of the struts.

12. A unit cell of claim 1 further comprising a planar structure supported by at least two of the struts.

13. A unit cell of claim 1 wherein the single unit truss is positioned at a centroid of the unit cell.

14. A unit truss for a lattice structure comprising:
a junction; and
fourteen struts coupled to the junction, six of the struts being mutually orthogonal at junctions of the mutually orthogonal struts, and eight of the inner struts oriented diagonally relative to each of the six mutually orthogonal struts.

15. The unit truss of claim 14, wherein at least one of the struts has a cross-sectional shape that varies along the strut.

16. The unit truss of claim 14, wherein the six mutually orthogonal struts are arranged to bear tensile and compressive loads applied to the unit truss, and the eight diagonally-oriented struts are arranged to bear shear loads applied to the unit truss.

17. The unit truss of claim 14, wherein the six mutually orthogonal struts are made of a first material and the eight diagonally-oriented struts are made of a second, different material.

18. A lattice formed with at least one of the unit trusses of claim 14.

19. The unit truss of claim 14, wherein the junction is configured to minimize stress on the struts.

20. The unit truss of claim 14, wherein the junction is hollow.

21. A lattice structure comprising:
a unit cell of material having a plurality of struts that absorb loads selected from a group consisting of tensile loads, compressive loads, and shear loads; and
a dual cell of material enclosing the unit cell, the dual cell represented in part by intersections between a unit cell and octahedra.

22. The lattice structure of claim 21, further comprising ligaments that couple the dual cell to the unit cell.
